(19) United States
(12) Patent Application Publication
(10) Pub. No.: US 2007/0216650 A1
(43) Pub. Date: Sep. 20, 2007

(54) Data Recording Device for Data Processing Units

(75) Inventors: Bernd Frohlich, Weimar (DE); Jan Hochstrate, Gerstungen (DE); Gunnar Bach, Unterkoditz (DE)

Correspondence Address: MAYER & WILLIAMS PC, 251 NORTH AVENUE WEST, 2ND FLOOR, WESTFIELD, NJ, 07090, US

(73) Assignee: Bauhaus-Universitat Weimar, a Germany University, Weimar (DE)

(21) Appl. No.: 10/565,878

(22) PCT Filed: Jul. 22, 2004
(86) PCT No.: PCT/EP04/08193

§ 371 Date: Mar. 29, 2007

(30) Foreign Application Priority Data
Jul. 22, 2003 (DE) 103 33 178.6

(51) Int. Cl. G06F 3/033

(52) U.S. Cl. 345/167

(57) ABSTRACT

The invention relates to a data-registration device for data-processing units, in particular for the registration of multi-dimensional coordinates. Said devices serve for the recognition or input of data defining a movement and/or a position in a multi-dimensional space. According to the invention, the data-registration device consists of a stand, a retainer element mounted on the stand such as to be displaced in at least two directions, an operating ball mounted in the retainer element such as to be rotated but not displaced, of which two at least partly diametrically opposed ball segment sections may be gripped with thumb and forefinger of one hand by the user, several sensors for registering the displacement of the retainer element and the rotation of the operating ball, and an interface unit that transmits the data provided by the sensors to the connected data-processing unit.

The invention relates to a data registration device for data processing systems based on the overall concept of Patent claim 1.

Generic data registration devices for data processing systems may generally be used in widely varying applications. Using such a data registration device, multi-dimensional coordinates may be determined or input. Such devices are often designated as input devices that serve for the input of positional or displacement parameters.

One of the most well known input or data registration devices is the so-called computer mouse. With this it is possible, to transfer via a user controled motion the resulting displacement or positional data to a conventional personal computer. For graphics-oriented software applications, a cursor is controlled on the display device by the computer mouse, whereby, depending on the position of this cursor within a display window, activation of the additional buttons on the mouse can initiate pre-determined program functions.

Progressive development of software applications has made it common in recent years to control virtual displacement and position of computer-simulated objects in three-dimensional space using suitable input or data registration devices. For example, data registration devices known as joysticks are used in CAD applications to control the display or in computer games to displace virtual objects.

For the sake of clarity, it will be assumed in the following that any three-dimensional space within which a real or virtual object is to be displaced may be described using a three-dimensional coordinate system. Unless otherwise specified, the following descriptions assume that the plane defined by the X-axis and the Y-axis is horizontal, while the Z-axis extends vertically perpendicular to these coordinate axes, penetrating that XY plane. The three degrees of translation or displacement may thus be precisely defined. The additional three degrees of rotation necessary for free displacement of an object through space may be indicated by three angular values ωₓ, ω_{y}, and ω_{z} that are to be understood as rotation about the three named displacement axes X, Y, and Z.

A graphics control unit with six degrees of movement is known from U.S. Pat. No. 5,565,891. This is to enable not only displacement of virtual objects within three-dimensional space, but also rotation of the virtual object along each of the displacement axes, so that any displacement and rotation of these objects may be recreated within a three-dimensional coordinate system. For this, the device shown in U.S. Pat. No. 5,565,891 possesses a rotatable ball (track-ball) secured within a retainer that may be displaced along two or three directions perpendicular to one another in order to register translatory displacements. The user may grasp the operating ball from above using several fingers in order at least to enable rotation about two axes.

The design selected in U.S. Pat. No. 5,565,891 includes a number of operating difficulties that complicate rapid, precise operation. Since the track-ball may be gripped only on its upper hemisphere, rotation in the angular directions ωₓ and ω_{y} is relatively easy. Rotation along direction ω_{z} about the Z-axis, however, presents difficulties, at least when a simultaneous undesired rotation along ωₓ and/or ω_{y} is to be avoided. For this reason, U.S. Pat. No. 5,565,891 also specifies a particular embodiment design in which rotation about the Z-axis perpendicular to the main plane of extension of the device is not performed by means of actuation of the operating ball, but rather by rotation of a funnel-shaped ball carrier. This allows more precise rotation along direction ω_{z}, but the user must move his hand from the operating ball to the ball carrier, which does not allow rapid operation. In the same manner, gripping the operating ball on the ball carrier or the overall unit is required if, instead of rotation, a displacement within the X-Y plane is desired. The graphics control device described in that patent document presents particular difficulties during registration of displacement data along the Z-axis, i.e., perpendicular to the main plane of the device, the X-Y plane. In order to register such displacements, one must in any case move one's hand from the operating ball to the ball carrier. It would be conceivable to exert force on the operating ball in the Z direction, but displacement of the operating ball in the opposite direction is not possible since the operating ball cannot be adequately securely held, or is not free to move in this direction within the ball carrier.

A three-dimensional cursor device with a rotatable ball is known from JP 10-207629. This device also serves for data registration to represent a displacement with six degrees of freedom. For this, the operating ball is mounted within a tong-shaped retainer element so that the user may grasp it. This allows rotation of the operating ball about three rotation axes perpendicular to one another. To register translatory displacement, the tong-shaped element is connected with a pivoting lever that is gripped by the user and that may be pivoted in various directions. This pivoting lever and its manner of function are comparable to a conventional joystick. The cursor device known from this patent document allows registration of spatial position and displacement data, but is also not optimally matched to the natural needs of the user because of its difficulty of operation. For example, simultaneous rotation and displacement presents particular difficulties since the user must either move his hand from the operating ball to the pivoting lever or operate these operating elements that are independent of one another using a priori with several fingers. Additionally, the tipping of the pivoting lever does not match the displacement motion actually to be simulated, so that a longer learning process is required in order to be able to specify precise displacement motions by means of corresponding pivoting of the pivoting lever. Additionally, pivoting of the pivoting lever along the X-Y directions induces alteration along the Z direction to the position of the operating ball, which leads to considerable problems in distinguishing a favorable displacement along the Z-axis from erroneous motion resulting from pivoting in this direction.

U.S. Pat. No. 5,589,828 publishes a converter that converts physical signals into electrical ones. A hand-operated input controller is involved that allows motions with six degrees of freedom, or converts the exerted forces into electrical signals with six degrees of freedom, and can also provide perceptible feedback (in the form of vibration). This device is operated as a joystick, i.e., forces exerted along the X- or Y-axis is achieved by tilting the operating lever. However, during this, the coordinates of the operating ball also are unintentionally altered at least along the Z-axis, as are the rotation coordinates. Free rotation of the operating ball is not possible because of the design indicated.

U.S. Pat. No. 5,620,371 concerns a computer trackball with a transparent spherical exterior shell within which a sphere with a rod magnet is mounted that is attracted by a magnet in the housing. This measure serves to hold a logo or image on the inner sphere always in the uppermost position independent of the position of the trackball. The inner sphere is held in place by the magnet. This device does not serve to restrain the trackball.

US 2002/0018592 A1 describes a mouse-like control device and an image processing device. The control device registers the rotation and acceleration of a control ball and their directions. The image processing device uses data from the control device to provide displays on the computer screen. Control of the object shown on the screen is via the control device.

It is the task of the invention to present an improved data registration device for data processing systems that avoids the disadvantages of the State of the Art named above. In particular, it should be possible for the user with one-hand operation to input or register rotation and translation data simultaneously. The ergonomics of the data registration device are to be so improved that rapid and precise movement of real or virtual objects is possible within three-dimensional space without a long learning process.

This task is fulfilled by the data registration device described in greater detail in Patent claim 1.

A particular advantage of the data registration device based on the invention is the fact that the operating ball can be rotated by the user very precisely about three mutually perpendicular axes. This is achievable since the operating ball may be grasped by two ball segment sections in any case that are at least partially diametrically opposed. The user may thus grasp at least a great circle of the operating ball so that precise rotations are possible about the axis extending perpendicular to the plane defined by the great circle in the user's grasp. Based on the selected grasping of the operating ball, it is simultaneously possible to displace the operating ball and thereby the retainer element affixed to it in one or more directions in order to register the desired data. The moving of hands among various operating elements in order to input rotation data or displacement data is not required. This not only allows a higher degree of precision during operation, but also a clear approximation of the real conditions to be controlled by the data registration device.

For this, it is advantageous if the retainer element can be displaced simultaneously along several axes and/or the operating ball may be rotated simultaneously about several axes. For example, diagonal displacement is possible. This configuration permits spatial displacement. Measurement of the displacement results in the simplest case along the three perpendicular spatial axes. In the mathematical sense, the axes need only be linearly independent, i.e., need only cover the three-dimensional space.

According to an advantageous embodiment example, the retainer element includes a frame-shaped ball mount that encloses the operating ball along a great circle either completely or at least in a scope greater than π or 180°. The operating ball is thus fixed against displacement in all directions of the frame-shaped ball mount. Suitable mounting elements that permit a very easy rotation of the operating ball are positioned within the ball mount.

Basically, it may be advantageous to mount the operating ball on four symmetrical points. The mounting points thus lie on a tetrahedron. Thus, the ball rotates very easily through all axes with low resistance. The suspension of the retainer element around the operating ball may be simply implemented using springs. The retainer element could, for example, be configured of tetrahedron frames, whereby a symmetrical suspension would be simplified. But a cubic frame with springs for ball suspension is conceivable.

It has been determined that it may be useful or adequate for certain applications to block the rotation of the operating ball temporarily or for the long term, or to admit one or several displacement devices, or to block them as necessary. An advantageous embodiment example thus distinguishes itself in that actuators are provided that exert a certain opposing force in reaction to control signals of the displacement of the retainer element and/or of the rotation of the operating ball. This force may be so regulated that specific displacement directions are completely blocked, made intentionally difficult, or even active displacement of the operating ball in specific directions is caused by the actuators in order to provide the user with force feedback via the data registration device that act upon the controlled real or virtual objects. In order to permit rotation of the operating ball about only one axis, a second guide element, for example, (e.g., a second mount ring) may be activated so that the operating ball is then suspended on two limiting lines that lie in parallel planes.

In an expanded embodiment example, the retainer element includes a key-shaped ball mount in which the operating ball is mounted with a ball segment that must be smaller than a hemisphere in order to allow the user in this case to grasp the operating ball along a great circle.

So that the operating ball cannot escape the key-shaped ball mount, and also so that tension forces can be applied to displace the operating ball from the key-shaped ball mount, then the operating ball in an expanded embodiment example is suspended within the key-shaped ball mount with the help of magnetic forces. In order simultaneously to maintain the low-friction rotatability of the ball, the operating ball is made of non-magnetic material and possesses a hollow cavity in which a holding ball of magnetizable material is positioned so that it may move freely. A permanent or electromagnet positioned near the ball mount exert magnetic force on the holding ball so that they press the operating ball into the ball mount.

It is useful for certain applications for the retainer element to possess an inner frame and an outer frame in addition to the ball mount that may be displaced perpendicularly with respect to each other. The inner frame allows displacement along a first direction (X) within the outer frame, while the outer frame is displaceable along a second direction (Y) relative to the stand of the data registration device. If displacement data along a third direction (Z) is to be registered, then either the ball mount, the inner frame, or the outer frame may be displaceable along this third direction, and may be equipped with suitable sensors. In any case, all displacement forces from the user are registered via the operating ball, and are passed from there to the displaceable elements along each direction.

Various sensors may be used to register the displacement data. Rotation of the operating ball may advantageously be registered by means of optical sensors. The displacement parameters may, for example, be registered by means of path, force, or acceleration sensors.

Additional advantages, details, and expansions result from the following description with reference to the Figures, which show:

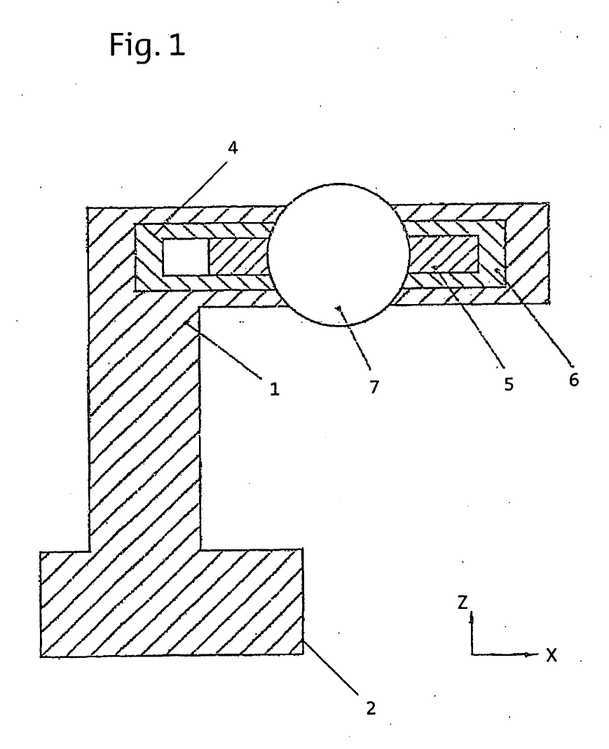

FIG. 1 a cutaway side view of a first embodiment example of the data registration device with a frame-shaped ball mount;

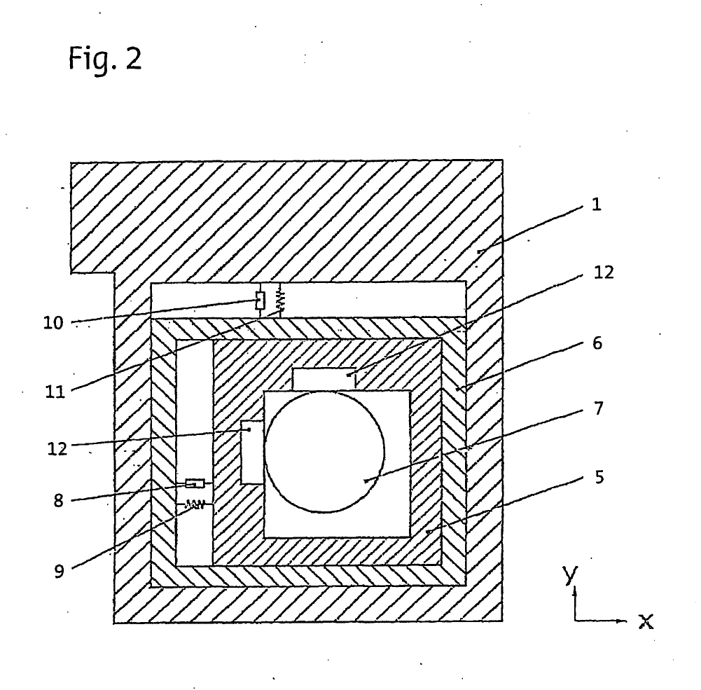

FIG. 2 a simplified cutaway view from above of the data registration device as in FIG. 1;

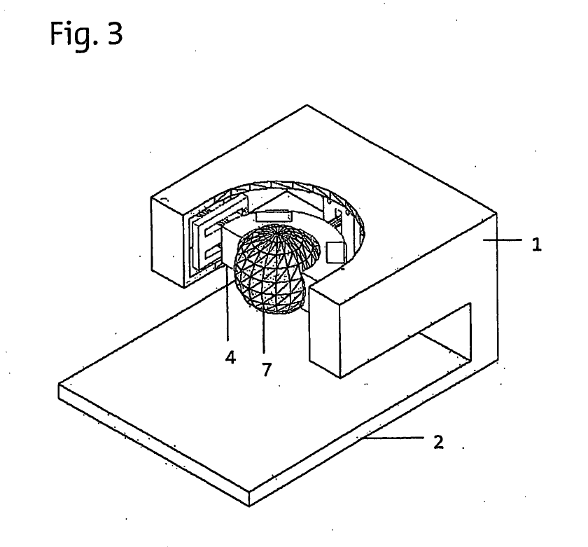

FIG. 3 a perspective representation of the principles of a second embodiment example of the data registration device with a half-ring shaped ball mount;

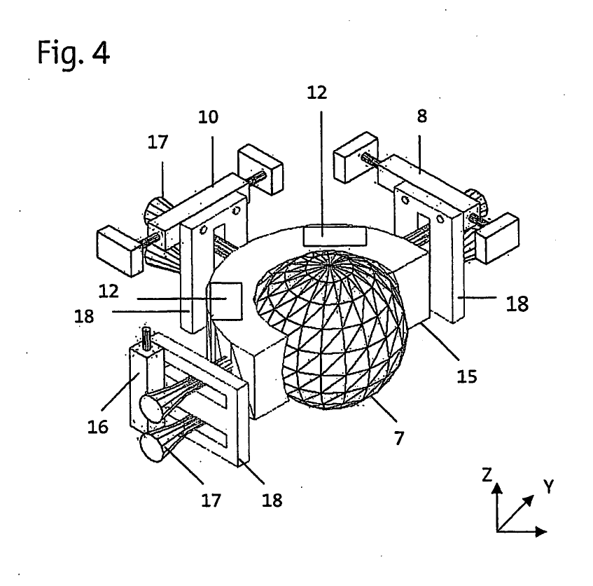

FIG. 4 a perspective detailed drawing of the data registration device as in FIG. 3, without housing elements;

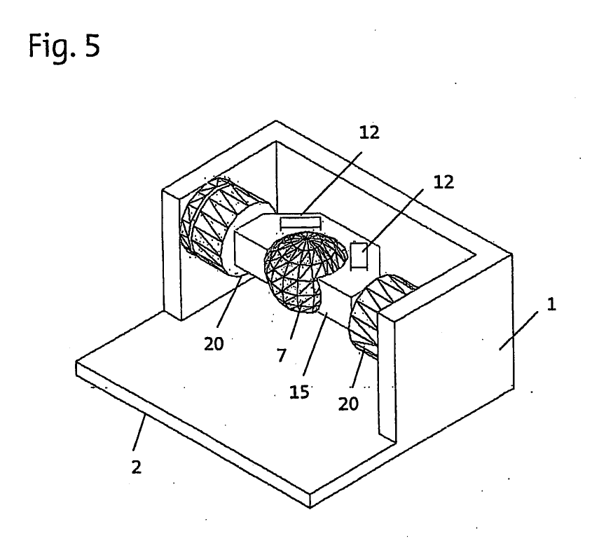

FIG. 5 a simplified cutaway view of a third embodiment example of the data registration device that uses conventional three-dimensional sensors to measure translation;

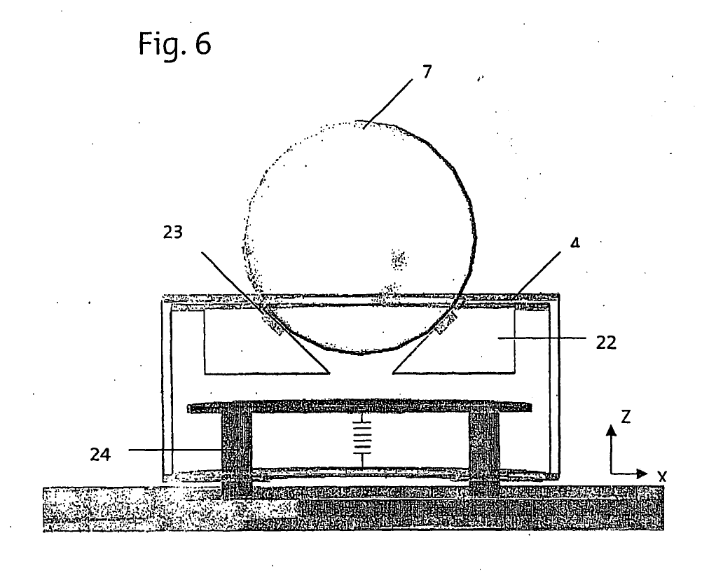

FIG. 6 a simplified cutaway view of a fourth embodiment example of the data registration device with a key-shaped ball mount;

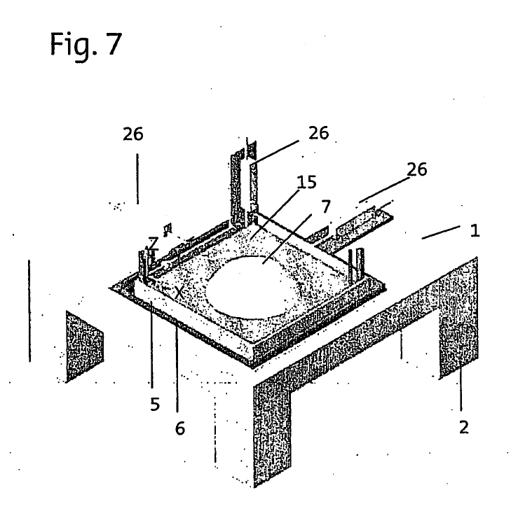

FIG. 7 a perspective representation of the principles of the fourth embodiment example of the data registration device with actuators.

FIG. 1 shows a simplified side cutaway view of a first embodiment example of a data registration device. The data registration device possesses a stand 1 that includes a foot 2 and a gallows-shaped extension arm 3 in the embodiment example illustrated here. A retainer element 4 is positioned on the stand 1 that, in this embodiment example, includes an inner frame 5 and an outer frame 6. The retainer element 4 carries an operating ball 7 that is so secured within the retainer element that two at least partially diametrically opposed ball segment sections extend out of the retainer element, and thus may be grasped by the user's fingers, or finger and thumb, of one hand. The operating ball 7 is affixed within the retainer element 4 using suitable mounting elements so that it may rotate. Further, sensors are provided that regist4er the rotation of the operating ball.

FIG. 2 shows the data registration device shown in FIG. 1 in a simplified side cutaway view, seen from above. For the sake of easier understanding, the axes of an X-Y coordinate system are drawn next to the data registration device. In order to provide input translation data via the data registration device, the inner frame 5 may be displaced along the X-axis within the outer frame 6. Displacement along the X-axis is registered by means of an X-axis sensor 8. Simultaneously, an X-axis return element 9 may be provided that returns the inner frame 5 to its rest position when the user exerts no force along the X-axis. In order to register displacement along the Y-axis, the outer frame 6 is mounted within the stand so as to be displaceable in this direction. A Y-axis sensor determines displacement of the outer frame 6, while a Y-axis return element 11 causes the outer frame 6 to return to its rest position when the user exerts no force along the Y-axis. The displacement of the inner frame relative to the outer frame may, for example, be measured using optical sensors.

Rotation of the operating ball 7 may be determined by means of rotation sensors 12. Proper positioning of the rotation sensors allows determination of all rotational movements of the operating ball about the three axes X, Y, Z defined in the spatial coordinate system.

In general, the issue is determination of displacement movement perpendicular to the X-Y plane, i.e., in the Z direction (see FIG. 1). For this, either the operating ball 7 with limiting ball mount in the inner frame 5 must be displaceable along the Z direction, or corresponding displacement results with respect to the outer frame, or a displacement of the outer frame 6 with respect to the stand 1. This displacement is registered by means of an additional Z-axis sensor (not shown).

It must be pointed out that, in general, relatively small displacement movements are adequate, especially if larger displacement movements are to be simulated by the exertion of lasting force exerted against a corresponding force sensor. Determination and processing of the corresponding data from force sensors is generally known by the State of the Art, so that a more detailed description is not required here. In this connection, reference is made to the fact that the data registration device also includes an interface unit that subjects the data delivered from the sensors to filtering, pre-processing, and formatting as necessary, and then transfers the data to a connected data processing system. Conventional data transfer formats and interfaces of modem computer technology are used for this.

FIG. 3 shows a simplified perspective view of a second embodiment example of the data registration device. For this, the foot 2 of the stand 1 is shaped to have a large surface area in order to simultaneously form the resting surface for the user's hand. An additional difference from the previously described embodiment example is the shape of the retainer element within which the operating ball 7 is mounted.

The details of this second embodiment example are visible in FIG. 4. The retainer element 4 in this case includes a ring-shaped ball mount 15 that extends in an angular section of more than π around a great circle of the operating ball 7 (in the illustrated example, around a narrow equatorial section). The operating ball 7 is thus held firmly in the ball mount 15, and cannot escape from the ball mount when displacement forces are exerted. Reference is made to the fact that the great circle surrounded by the ball mount in derivative embodiment examples may lie in a vertical or oblique plane to the extent that ergonomic designs may be achieved. Two rotation sensors 12 are again provided to register rotational displacement that here are integrated into the ball mount after being displaced 90°. This configuration of the rotation sensors is therefore not mandatory, but brings advantages to measurement-signal evaluation and accuracy.

The operating ball 7 usually possesses a diameter in the range of between 3 and 6 cm since this value has shown to be comfortable for the user. It is also possible to shape the ball mount to be adjustable (e.g., using special inserts) in order to be able to use operating balls of various sizes. In this manner, various users may adapt the data registration device to the size of their hand and fingers.

Several potentiometers are positioned in the embodiment example shown for the registration of displacement that is also exerted via the operating ball 7. The X-axis sensor 8 serves to register displacement along the X direction, while the Y-axis sensor 10 registers displacement along the Y direction. In the embodiment example shown, a Z-axis sensor 16 is additionally present by means of which displacement along the Z direction transferred to the ball mount 15 via the operating ball 7 is registered. To decouple the individual displacement components, each of the sensors is connected with the ball mount 15 by means of retainer rods, whereby these retainer rods are mounted within guide masks 18.

FIG. 5 shows a perspective view of a third embodiment example of the data registration device. The operating ball 7 is again mounted within a partial-ring shaped ball mount 15 so that it may rotate. Determination of rotation of the operating ball results via optical or similar rotation sensors 12. Reference is here made to the fact that not all applications require free rotatability of the operating ball 7 about several rotation axes through 360°. In certain circumstances, rotation limited by angle may be adequate. The ball mount is mounted between two conventional sensor units 20, as is used in an input device known on the market as a “space mouse.” The displacement of the ball mount 15 is thus possible through three mutually perpendicular directions within the limits specified by the sensor units. Spring-based sensors are located within the sensor units 20 that are capable of registering translation along the X-axis, Y-axis, and Z-axis. The entire assembly is again secured within the stand 1.

FIG. 6 shows a simplified cutaway view of a fourth embodiment example of the data registration device. The retainer element 4 possesses in this case a key-shaped ball mount 22 into which the operating ball 7 is mounted with its lower spherical section. The key-shaped ball mount 22 is so matched to the circumference of the operating ball 7 such that the equatorial plane of the operating ball extends out of the retainer element 4 in any case so that the user may grasp the operating ball 7 by up to a great circle. In order to provide easy rotatability of the operating ball 7, the key-shaped ball mount 22 may include a ball bearing 23 as mounting element on which the operating ball rests. Rotation of the operating ball 7 about the three coordinate axes X, Y, Z may also be determined by means of optical sensors or other suitable sensors to register a rotational motion of the retainer element. The retainer element 4 is also coupled with a sensor unit 24 that misses displacement of the retainer element along the X-axis, Y-axis, and Z-axis. An example of the design of such a sensor unit is again known from the “space mouse.”

To the extent that the operating ball 7 is positioned in the key-shaped ball mount 22 only in the manner shown, no defined displacement forces may be created along the positive Z-axis since the operating ball 7 would escape from the ball mount 22 because of tension force. On the other hand, pressure forces that may be registered by a corresponding Z-axis sensor as displacement may be exerted along the negative Z-axis with no complication. This embodiment example may, however, be expanded in that the operating ball may be made hollow and may consist of non-magnetic material. A smaller sphere capable of magnetization is inserted into the spherical cavity within the operating ball 7 that is free to move within this cavity. An additional magnetic source is provided in the area of the retainer element that attracts the sphere capable of magnetization into the ball mount, thus exerting adequate force on the operating ball 7. The operating ball 7 can no longer be extracted from the key-shaped ball mount because of the acting magnetic forces, but rather remains easily rotatable because of suitable mounting.

FIG. 7 shows a simplified perspective view of a fourth embodiment example of the data registration device. The basic design of this embodiment example corresponds to that described in connection with FIGS. 1 and 2. The operating ball 7 is also in this case mounted within the frame-shaped ball mount 15 so that it may rotate, whereby here the ball mount completely surrounds the operating ball in the area of its equatorial plane. The retainer element 4 again possess an inner frame 5 and an outer frame 6, each of which may be displaced along a given displacement direction. Further, three motor potentiometers 26 are provided that serve both as sensors for displacement along the corresponding direction, and also generate an opposing force as a result of electrical actuation that acts against the displacement force exerted by the user, or that reinforces it. One of the motor potentiometers acts against the outer frame 6 along the X-axis. A second motor potentiometer acts against the inner frame 5 along the Y-axis. Finally, the third motor potentiometer acts against the frame-shaped ball mount 15 that is mounted within the inner frame 5 to be displaceable along the Z-axis. In this embodiment example, the inner frame 5 and the outer frame 6 may not be displaced along the Z-axis.

The motor potentiometers may be replaced in expanded embodiment examples, for example, by moving coils or electromagnets. The use of hydraulic or pneumatic cylinders or the application of step motors is also conceivable to create an opposing force. In the same manner, opposing forces may be exerted on the operating ball in order to brake, fully block, or amplify rotation initiated by the user.

Creation of opposing or reinforcing forces is possible by means of feedback coupling of the controlled process. If, for example, a robot arm is to be controlled by the data registration device, then an opposing force may be created when the robot arm violates pre-determined limits. It would also be conceivable for software applications that the actuators already providing the opposing forces are actuated in order make limits within a virtual space perceptible to the user.

Buttons or switches may also be mounted on the data registration device in a known manner by means of which the user may generate additional control signals and transmit them to the data-processing system, for example in order to invoke certain functions within a software application.

In general, reference is made here to a significant advantage of the data registration device based on the invention. In contrast to devices available on the market, it is possible here to simulate the displacement of objects through space by means of actual displacement of the data registration device. Simultaneously, the rotation of an object may be caused by a similar rotation of the operating ball. The user must therefore undertake no mental or motor implementation of various motion processes.

Moreover, application options if the data registration device based on the invention also exist in conventional configurations, e.g., for the control of a cursor in graphic user interfaces of software applications. The option to register the position and motion parameters within a three-dimensional space and with six degrees of movement freedom opens numerous application realms. For example, the data registration device may be used for the control of CAD applications or three-dimensional image-processing programs. Also, robotic grippers, monitoring cameras, or similar devices for which spatial navigation is desired may be controlled.

| | |
|---|---|
| 1 | Stand |
| 2 | Foot |
| 3 | Extension arm |
| 4 | Retainer element |
| 5 | Inner frame |
| 6 | Outer frame |
| 7 | Operating ball |
| 8 | X-axis sensor |
| 9 | X-axis return element |
| 10 | Y-axis sensor |
| 11 | Y-axis return element |
| 12 | Rotation sensors |
| 15 | Frame-shaped ball mount |
| 16 | Z-axis sensor |
| 17 | Retainer rods |
| 18 | Guide masks |
| 20 | Sensor units |
| 22 | Key-shaped ball mount |
| 23 | Ball bearing |
| 24 | Sensor unit |
| 26 | Motor potentiometer |

1. Data registration device for data processing systems, particularly for the determination of multi-dimensional coordinates created by means of exertion of displacement and/or rotational forces, comprising
a stand;
a retainer element mounted in the stand such that the retainer element may be displaced in at least two mutually perpendicular directions;
an operating ball that may be rotated through three axes but not displaced within the retainer element;
at least one sensors to determine the displacement of the retainer element and the rotation of the operating ball;
an interface unit that transmits data delivered from the sensors to a connected data processing system;
wherein the operating ball is mounted within the retaining element such that it may be grasped on two at least partially diametrically opposed sphere segment sections, and wherein the displacement forces and the rotation forces with respect to all axes may be exerted by means of the operating ball.

2. Data registration device per claim 1, wherein the retainer element may be simultaneously displaced in the direction of several displacement axes, and wherein the operating ball may be rotated simultaneously about several axes.

3. Data registration device per claim 1 wherein the retainer element possesses a frame-shaped ball mount that surrounds the operating ball along a great circle in a surrounded section greater than π.

4. Data registration device per claim 1 wherein the retainer element includes a key-shaped ball mount.

5. Data registration device per claim 4, wherein the operating ball is mounted magnetically within the key-shaped ball mount, wherein the operating ball is hollow and is made of a non-magnetic material, wherein a magnetizable retaining ball is mounted within the operating ball so that it may move freely, and wherein a magnetic field source positioned outside the operating ball attracts the retaining ball into the key-shaped ball mount, and wherein the operating ball is mounted in the ball mount such that it may rotate.

6. Data registration device per claim 3, wherein the retainer element includes the ball mount, an inner frame, and an outer frame, wherein by the ball mount is mounted within the inner frame which itself is mounted in the outer frame such as to be displaceable along a first direction, which in turn is mounted in the stand such as to be displaceable along a second direction perpendicular to the first direction, and wherein at least one of the components of the retainer element is displaceable along a third direction that is perpendicular to the first and the second direction.

7. Data registration device per claim 1, further comprising return elements that return the retainer element or its components to a rest position when no displacement force is being exerted.

8. Data registration device per claim 1, wherein displacement of the retainer element is registered by path, force, or acceleration sensors.

9. Data registration device per claim 1, further comprising at least two motion sensors positioned within the retainer element that register the rotation of the operating ball about three mutually-perpendicular axes.

10. Data registration device per claim 9, wherein the motion sensors are optical sensors that sample a surface of the operating ball and its rotation.

11. Data registration device per claim 1, further comprising additional actuators that oppose or reinforce a varying force in reaction to control signals from the user resulting from displacement of the retainer element or rotation of the operating ball.

12. Data registration device per claim 1, further comprising additional switches that transmit additional control signals to the data processing system upon actuation.
